(19) United States
(12) Patent Application Publication
(10) Pub. No.: US 2015/0358770 A1
(43) Pub. Date: Dec. 10, 2015

(54) ELECTRONIC DEVICE AND COMPUTER-READABLE COMPUTER PROGRAM PRODUCT

(71) Applicant: NIKON CORPORATION, Tokyo (JP)

(72) Inventors: Sho Somiya, Tokyo (JP); Kenjiro Iohara, Tokyo (JP); Hiromi Kuwata, Tokyo (JP); Noriaki Mochimizo, Tokyo (JP); Shutaro Teramoto, Tokyo (JP); Masakazu Sekiguchi, Tokyo (JP)

(73) Assignee: NIKON CORPORATION, Tokyo (JP)

(21) Appl. No.: 14/409,123

(22) PCT Filed: Nov. 13, 2012
(86) PCT No.: PCT/JP2012/079332

§ 371 Date: Apr. 24, 2015

(30) Foreign Application Priority Data
Jun. 20, 2012 (JP) 2012-138970

(51) Int. Cl. H04W 4/02

(52) U.S. Cl. CPC H04W 4/02

(57) ABSTRACT

An electronic device includes: a communication unit that communicates with a first device through intra-body communication via a body of a user or near field communication; a position obtaining unit that obtains position information of the user; and a storage unit that stores information on use of the first device on a basis of a communication history between the first device and the communication unit, and the position information of the user, and can easily record play information.

### CROSS-REFERENCE TO RELATED APPLICATION(S)

This application is a U.S. National Stage Application, which claims the benefit under 35 U.S.C. §371 of PCT International Patent Application No. PCT/JP2012/079332, filed Nov. 13, 2012, which claims the foreign priority benefit under 35 U.S.C. §119 of Japanese Patent Application No. 2012-138970, filed Jun. 20, 2012, the contents of which are incorporated herein by reference.

### BACKGROUND

1. Field

The present invention relates to electronic devices and computer-readable computer program products.

2. Description of Related Art

In some sports games, players record their own results of a game. For example, in a golf game, a golf player records the number of shots in each hole on a score card during the game, and records a play score. However, during the play, the player has no choice but to recall information on, for example, a position where the nth shot is performed, a position where the miss shot is performed, and the player's posture and the wind direction in shooting. Further, when counting on the number of shots in each hole by themselves, they might count the number by mistake. Therefore, there is proposed an information recording system using a golf ball with a wireless IC tag and an information reader device embedded in the ground of golf courses (for example, see Patent Document 1).

### PATENT DOCUMENTS

Patent Document 1: Japanese Patent Application Publication No. 2005-102902

### SUMMARY

However, the information recording system described above is not practical because of workloads for introduction thereof, a cost problem, and the like.

Embodiments of the present invention have been made in view of the above problems, and aims to provide an electronic device capable of easily recording play information.

The electronic device includes: a communication unit that communicates with a first device through intra-body communication via a body of a user or near field communication; a position obtaining unit that obtains position information of the user; and a storage unit that stores information on use of the first device on a basis of a communication history between the first device and the communication unit, and the position information of the user.

In this case, the storage unit may store the information on use of the first device in association with a movement distance of the user based on the position information of the user. Additionally, in the electronic device, the communication unit may be capable of communicating with a second device different from the first device through intra-body communication or near field communication, and a determination unit may be provided for determining the movement distance of the user depending on communication between the second device and the communication unit.

The electronic device may include a first input unit that inputs information generated by using the first device, wherein the storage unit may store the information on use of the first device depending on the generated information. In this case, the information generated by using the first device may be information on sound generated by using the first device.

The electronic device may include a second input unit that inputs information on environment of a position where the first device is used, wherein the storage unit may store the information on use of the first device in association with the information on environment of the position where the first is used. Further, the electronic device may include a third input unit that inputs information on posture of the user, wherein the storage unit may store the information on use of the first device in association with the information on posture of the user.

Further, in the electronic device, the communication unit may be capable of communicating with a second device different from the first device through intra-body communication or near field communication, and when the user has the first device and the second device and uses one of the first device and the second device without using the other one, the storage unit may store information on an unused device in association with information on a used device. Furthermore, the electronic device may include a display unit that displays the information stored in the storing unit. In addition, the electronic device may include a transmission unit that transmits the information stored in the storing unit to an external device. Additionally, the electronic device may include a report unit that reports the information stored in the storing unit to the user depending on the position information obtained by the position obtaining unit.

An electronic device includes: a communication unit that communicates with a first device through intra-body communication via a body of a user or near field communication; and a storage unit that stores information on use of the first device on a basis of a way to hold and swing the first device.

Embodiments of the present invention have an advantage of easily recording play information.

### BRIEF DESCRIPTION OF DRAWINGS

These and/or other aspects and advantages will become apparent and more readily appreciated from the following description of the embodiments, taken in conjunction with the accompanying drawings of which:

FIG. 1 is a view illustrating a configuration of an electronic device system in accordance with an embodiment;

FIG. 2 is a view illustrating a situation where the electronic device system is used;

FIG. 3 is a view illustrating an example of a golf club and an installation position of a club device;

FIG. 4 is a view illustrating an example of play information stored in a storage unit of a mobile terminal;

FIGS. 5A and 5B are views illustrating an example of play information displayed by a display unit of the mobile terminal;

FIG. 6 is a view illustrating an example of a configuration of hardware of a control unit of the mobile terminal;

FIG. 7 is a functional block view illustrating an example of a function of the control unit of the mobile terminal;

FIG. 8A is a flowchart illustrating process executed by a control unit of a communication device, and FIG. 8B is a flowchart illustrating process executed by the control unit of the mobile terminal;

FIG. 9 is a view illustrating an example of a golf course; and

FIGS. 10A to 10C are views explaining data registration process of FIG. 8.

### DESCRIPTION OF EMBODIMENTS

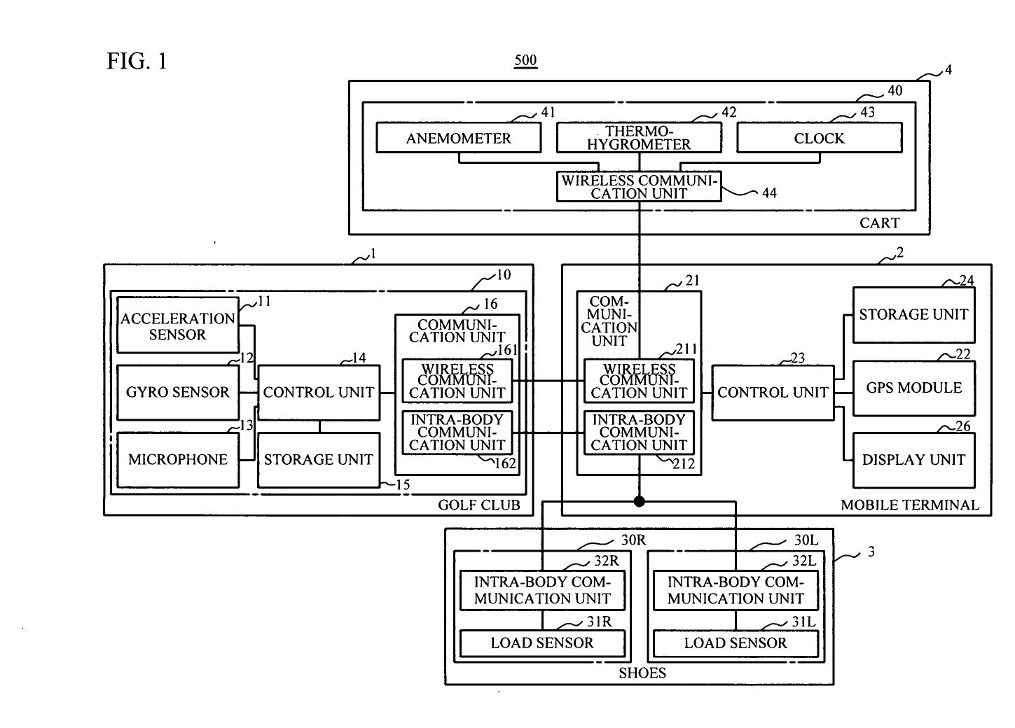

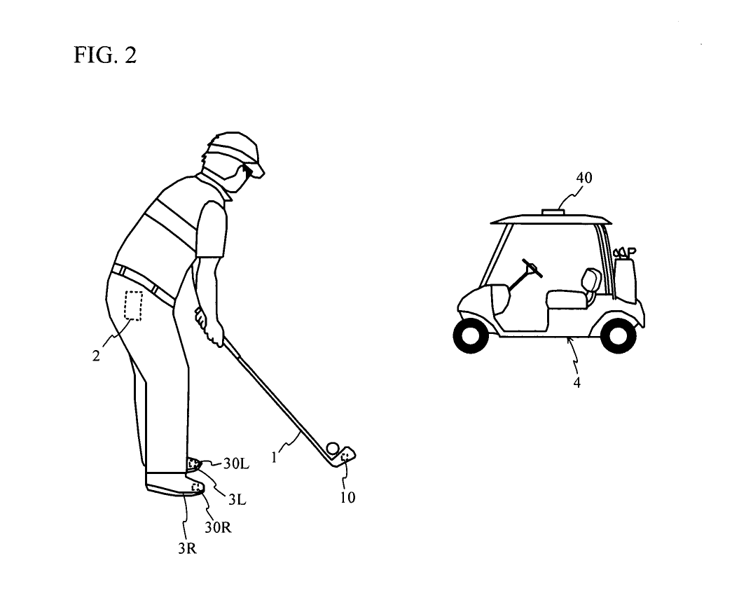

Hereinafter, a description will be given of the embodiments in detail with reference to FIG. 1 through FIG. 10C. In FIG. 1, a configuration of an electronic device system 500 in accordance with the embodiment is illustrated in a block view. Further, in FIG. 2, the situation where the electronic device system 500 is used is illustrated.

The electronic device system 500 is used when a user plays sports. In the present embodiment, as illustrated in FIG. 2, a description will be given of the system used when the user plays golf.

As illustrated in FIGS. 1 and 2, the electronic device system 500 includes: a club device 10 provided in a golf club 1; a mobile terminal 2; shoe devices 30R and 30L provided in a pair of shoes 3; and a cart device 40 provided in a cart 4.

(Club Device 10)

As illustrated in FIG. 1, the club device 10 includes an acceleration sensor 11, a gyro sensor 12, a microphone 13, a control unit 14, a storage unit 15, and a communication unit 16. In addition, the golf club 1 has types such as a driver, an iron, and a putter (P), the driver has types such as 1W, 3W, and 5W, and the iron has types such as 3I to 9I, PW (pitching wedge), AW (approach wedge), and SW (sand wedge). In the present embodiment, the club device 10 is provided in each club. Further, the configuration of the club device 10 described above is not always fully required, may be partially omitted, and may be provided in the mobile terminal 2.

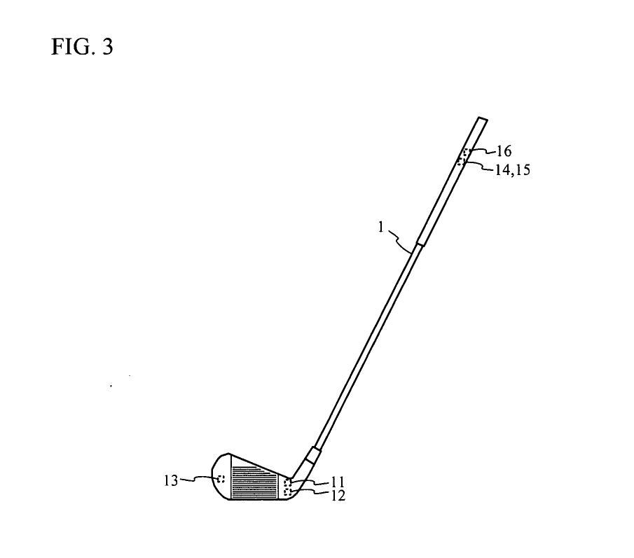

As illustrated in FIG. 3, the acceleration sensor 11 is provided in a head portion of the golf club 1, and detects acceleration of the head portion of the golf club 1. The acceleration sensor 11 may employ a piezoelectric element or a strain gauge. The number of axes of the acceleration sensor 11 may be arbitrarily selected from one to three, and the number of the acceleration sensors 11 may be arbitrarily determined.

The gyro sensor 12 detects a Coriolis force generated by the effect of angular velocity by using a piezoelectric element, is provided in the head portion of the golf club 1 in the present embodiment (see FIG. 3), and detects the angular velocity of the golf club 1. The number of axes of the gyro sensor 12 may be selected from one through three, and the number of the gyro sensor 12 may be arbitrarily determined.

In the present embodiment, the acceleration sensor 11 and the gyro sensor 12 are provided in the golf club 1, thereby detecting the user's swing of the golf club 1 by using each sensor.

As illustrated in FIG. 3, the microphone 13 is provided in the head portion of the golf club 1, and collects sound in accordance with the swing of the golf club 1. The microphone 13 is preferably with good directivity such as a microphone containing a preamplifier. When the acceleration sensor 11 and the gyro sensor 12 detect the swing of the golf club 1, outputs from the microphone 13 are amplified by an amplifier and is recorded as sound data (for example, See Japanese Patent Application Publication 10-267744).

The control unit 14 overall controls the club device 10, and includes a CPU (Central Processing Unit), a RAM (Random Access Memory), and a ROM (Read Only Memory). In the present embodiment, the control unit 14 controls transmission of the data to the mobile terminal 2, controls the microphone 13 to collect sounds, and control the storage unit 15 to store sound data of collected sounds. The storage unit 15 stores the sound data of sounds collected by the microphone 13, and the number information on the golf club 1 (1W, 3W, 5W, 3I to 9I, PW, AW, SW, P, and the like.). Additionally, the storage unit 15 and the control unit 14 may also be provided at any position of the golf club 1, and they are provided in a grip portion of the golf club 1 in the present embodiment as illustrated in FIG. 3.

The communication unit 16 communicates with another device, and includes: an intra-body communication unit 162 performing intra-body communication by an electrode provided on the grip portion of the golf club 1; and a wireless communication unit 161 performing wireless communication. In the present embodiment, the communication unit 16 communicates with the mobile terminal 2 and transmits the number information on the golf club 1 stored in the storage unit 15 and the sound data of sounds collected by the microphone 13 to the mobile terminal 2. Additionally, there are some methods for intra-body communication including: an electric current method that passes a minute electric current through a human body and modulates the electric current to transmit information; and an electric field method that modulates an electric field induced on the surface of a human body to transmit information. In the present embodiment, any of the electric current method and the electric field method can be used. Also, intra-body communication is performed not only when the user's hand is bare (that is, when the user's hand makes direct contact with the electrode) but also when the user wears gloves (that is, when the user's hand faces the electrode). Further, a small square indicates the communication unit 16 in FIG. 3, and the electrode of the intra-body communication unit 162 is provided so as to perform intra-body communication through the left hand or the right hand when the user touches any position of the grip portion. Furthermore, in order to determine whether the user grips the end side or the bottom side of the grip portion, that is, in order to determine the position of the hand relative to the grip portion, for example, plural electrodes of the intra-body communication unit 162 may be separately provided. Even in a care of using the same golf club 1, there is a difference in flight distance between a case of gripping the end side of the grip portion and a case of gripping the bottom side thereof.

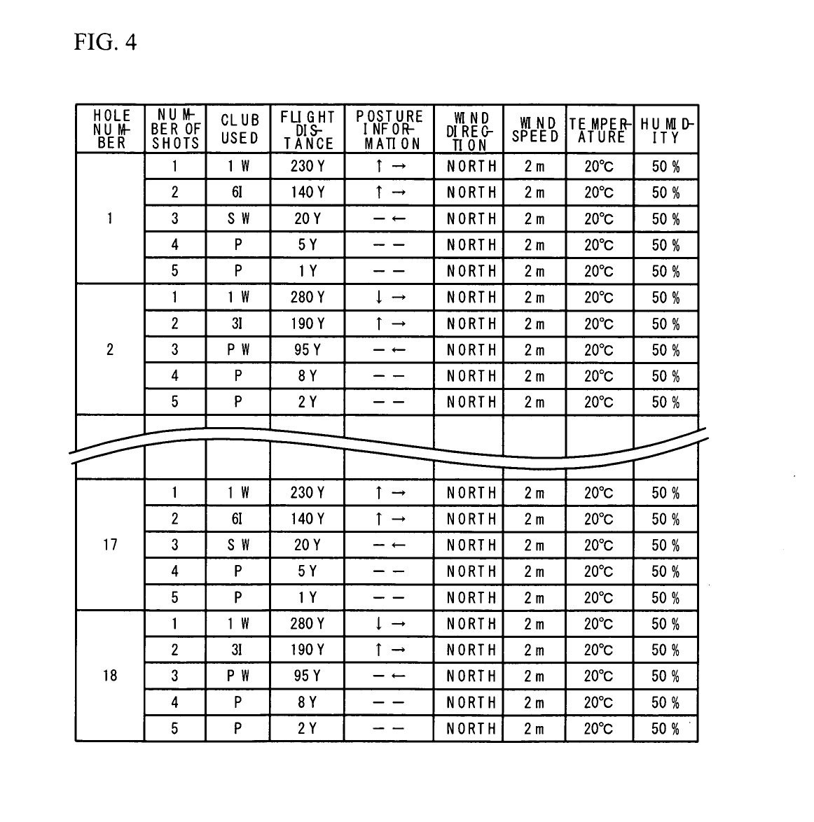

When the flight distance is recorded in a table, to be described later, illustrated in FIG. 4, the way to grip the golf club 1 may be recorded, and the data of an average flight distance corresponding to the way to grip the golf club 1 may be recorded.

(Shoe Devices 30R and 30L)

The shoe device 30R is provided in a right shoe 3R, and the shoe device 30L is provided in a left shoe 3L. The shoe device 30R includes a load sensor 31R and an intra-body communication unit 32R. Likewise, the shoe device 30L includes a load sensor 31L and an intra-body communication unit 32L. The load sensors 31R and 31L detect the positions of the respective shoe 3R and 3L to which the load is applied. By using the detection results of the load sensors 31R and 31L, the posture of the user can be detected.

The intra-body communication unit 32R performs intra-body communication with an intra-body communication unit 212 of the mobile terminal 2 by using the electrode provided in the right shoe 3R, and transmits the detection results of the load sensor 31R to the intra-body communication unit 212. The intra-body communication unit 32L performs intra-body communication with the intra-body communication unit 212 of the mobile terminal 2 by using the electrode provided in the left shoe 3L, and transmits the detection results of the load sensor 31L to the intra-body communication unit 212. Additionally, the electrode for intra-body communication is provided in a position making contact with a foot of the user (the inside of the shoe 3R or 3L). Intra-body communication can be performed not only when the user's foot is bare (that is, when the electrode makes contact with the foot) but also when the user wears socks (that is, when the electrode faces the foot).

(Cart Device 40)

The cart device 40 is provided, for example, in a ceiling portion of the cart 4 (see FIG. 2), and includes an anemometer 41, a thermo-hygrometer 42, a clock 43, and a wireless communication unit 44, as illustrated in FIG. 1.

The anemometer 41 detects wind direction and wind speed in the play. The thermo-hygrometer 42 detects temperature and humidity in the play. The clock 43 obtains date and time information in the play. The wireless communication unit 44 performs wireless communication with the wireless communication unit 211 of the mobile terminal 2. The wireless communication unit 44 transmits the outputs from the anemometer 41, the thermo-hygrometer 42, and the clock 43 to the wireless communication unit 211 through wireless communication.

(Mobile Terminal 2)

The mobile terminal 2 is an information device that is used and carried by the user. The mobile terminal 2 can employ a mobile phone, a smart phone, a PHS (Personal Handy-phone System), a PDA (Personal Digital Assistant), or the like. However, in the present embodiment, the mobile terminal 2 is a smartphone. The mobile terminal 2 includes a telephone function, a communication function for connecting to the Internet, and a data process function for executing the program. In addition, required components of the mobile terminal 2 may be provided in a watch, glasses, a hearing aid, a hat, shoes 3R and 3L, or a remote control for remotely operating the cart 4 as a mobile terminal.

The mobile terminal 2 includes a communication unit 21, a GPS (Global Positioning System) module 22, a storage unit 24, a display unit 26, and a control unit 23.

The communication unit 21 communicates with another device, and includes: the intra-body communication unit 212 performing intra-body communication by an electrode attached to the user or provided in the mobile terminal 2; and a wireless communication unit 211 performing wireless communication. In the present embodiment, the intra-body communication unit 212 performs intra-body communication with the club device 10 in the state where the user holds the golf club 1, and receives the number information on the club and the sound data. Further, the intra-body communication unit 212 performs intra-body communication with the shoe devices 30R and 30L by the electrodes provided in the shoes 3R and 3L, respectively, and receives the information on the posture of the user. On the other hand, the wireless communication unit 211 communicates with the cart device 40, and receives information on wind direction, wind speed, temperature, humidity, time, and the like. Further, when the communication state of the intra-body communication unit 212 is unstable, the number information on the club and the sound data from the club device 10 may be received by the wireless communication unit 211. Furthermore, not only when the user makes direct contact with the mobile terminal 2, but also when the user makes contact with the mobile terminal 2 through a shirt or pants, intra-body communication can be performed.

The GPS module 22 is a sensor for detecting the position (e.g. latitude and longitude) of the mobile terminal 2. In the present embodiment, because the mobile terminal 2 is held by the user (see FIG. 3), the GPS module 22 detects the position of the user.

The storage unit 24 is, for example, a nonvolatile memory or a hard disk, and stores the play information of the user. Herein, the information stored in the storage unit 24 will be described with reference to FIG. 4.

As illustrated in FIG. 4, the storage unit 24 stores the play information such as “hole number”, “number of shots”, “club used”, “flight distance”, “posture information”, “wind direction”, “wind speed”, “temperature”, and “humidity”.

“Hole number” indicates the number of each hole of the golf course. “The number of shots” indicates what number shot is taken in each hole. “Used club” stores the number information on the club used by the user in the nth shot. “Flight distance” stores the flight distance of the ball in the nth shot. “Posture information” stores the posture of the user when the user hits the ball in the nth shot. In the present embodiment, as an example, arrows on the left side indicate the inclination of the user in the forward and backward directions. Thus, an up arrow on the left side means that the toes face upward, a down arrow means that the toes face downward, and “-” means flat in the forward and backward directions. Further, in the present embodiment, as an example, arrows on the right side indicate the inclination of the user in the right and left directions. Thus, a right arrow on the right side means that the posture of the user inclines to the right side (the right foot is lower than the left foot), a left arrow indicates the posture of the user inclines to the right side (the left foot is lower than the right foot), and “-” means flat in the right and left directions. For example, in the second shot in the hole number “1”, the arrow on the left side is up, and the arrow on the right side is right. Thus, the posture of the user is “the left toe is up”.

“Wind direction” and “wind speed” respectively store the direction and the speed of the wind blowing when the nth shot is performed. In addition, “temperature” and “humidity” respectively store humidity and temperature when the nth shot is performed. Thus, in the present embodiment, the information such as flight distance, posture information, wind direction, wind speed, humidity, and temperature is stored in association with the information on the club used in the nth shot.

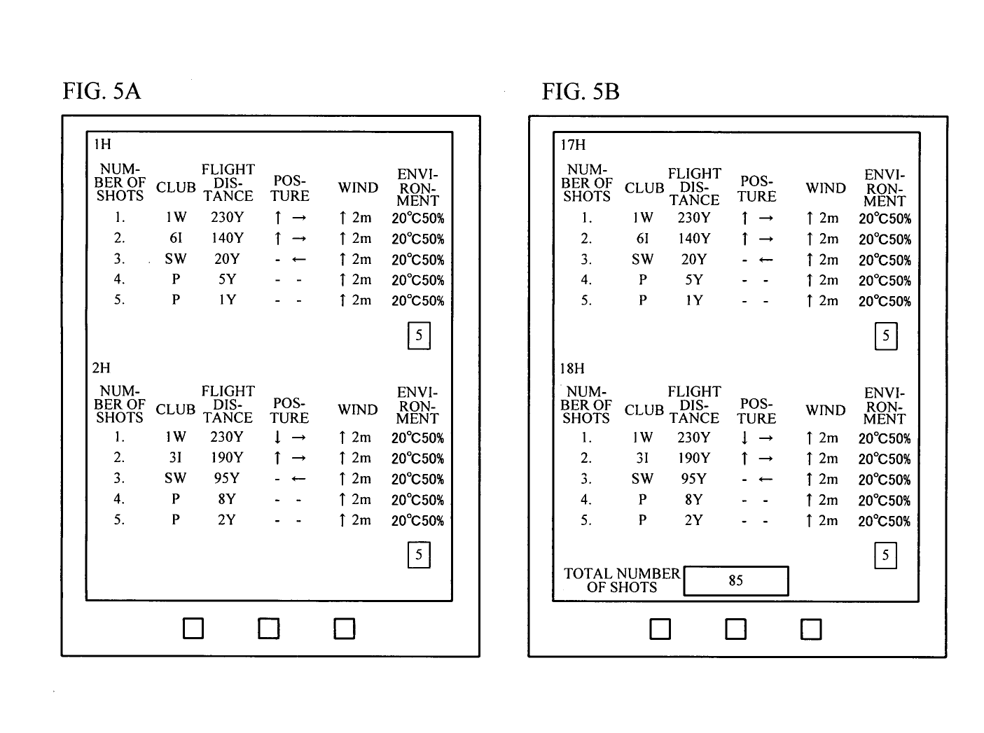

Referring back to FIG. 1, the display unit 26 is, for example, a device using liquid crystal display elements, and displays the play information stored in the storage unit 24 under the control of the control unit 23. FIGS. 5A and 5B illustrate an example of the play information displayed by the display unit 26. The display unit 26 displays the play information illustrated in FIG. 5 in such layout and manner that it is easy for the user to see the play information. The display unit 26 also displays the total number of shots per hole and the total number of the shots per game. As for the item of “wind” illustrated in FIGS. 5A and 5B, as an example, the up arrow indicates a tailwind, and the down arrow indicates a headwind.

The control unit 23 overall controls the mobile terminal 2. In the present embodiment, the control unit 23 controls the storage unit 24 to store various kinds and controls the display unit 26 to display the play information.

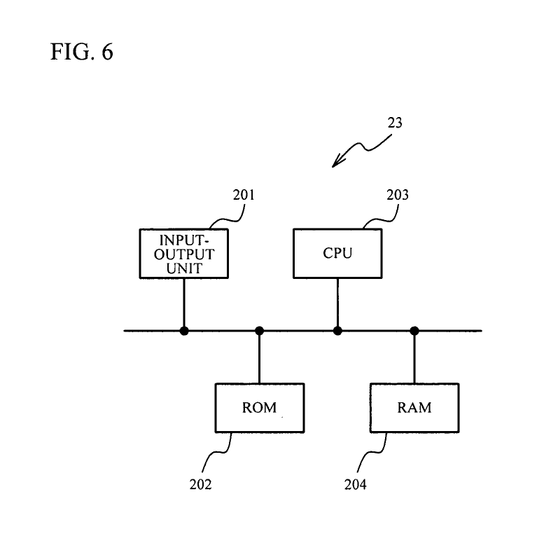

FIG. 6 illustrates an example of the hardware configuration of the control unit 23. As illustrated in FIG. 6, the control unit 23 includes an input-output unit 201, a ROM 202, a CPU 203, and a RAM 204.

The input-output unit 201 transmits and receives data to and from the communication unit 21, the GPS module 22, the storage unit 24, and the display unit 26. The ROM 202 stores a program for calculating the flight distance of the ball shot by the user. The CPU 203 reads and executes the program stored in the ROM 202. The RAM 204 stores temporary data used for executing the program.

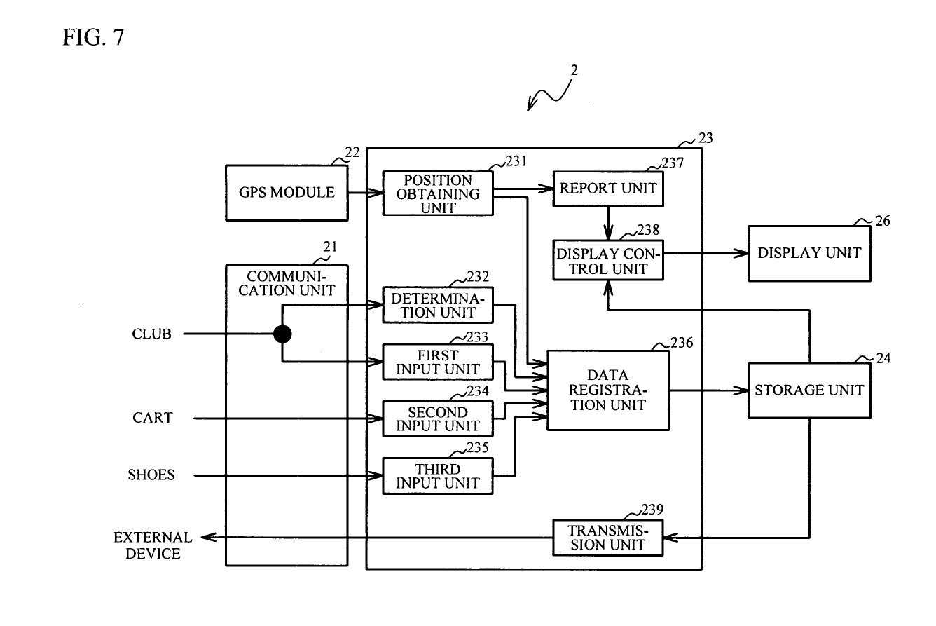

Next, a description will be given of an example of a function, which the control unit 23 of the mobile terminal 2 has, achieved by cooperation of the hardware resources and the software described above with reference to FIG. 7. As illustrated in FIG. 7, the control unit 23 includes a position obtaining unit 231, a determination unit 232, a first input unit 233, a second input unit 234, a third input unit 235, a data registration unit 236, a report unit 237, a display control unit 238, and a transmission unit 239.

The position obtaining unit 231 obtains the position information of the mobile terminal 2 (the position information of the user) from the GPS module 22, and inputs the position information of the user to the data registration unit 236 and the report unit 237.

The determination unit 232 determines whether or not the user's shot is a tee shot (first shot in each hole). In the present embodiment, the determination unit 232 obtains the number information on the club from the club device 10 through the communication unit 21, determines whether or not the user's shot is the tee shot on the basis of the number information on the club, and inputs the determination result to the data registration unit 236. Additionally, instead of these arrangements, the determination unit 232 may detect the position information on the tee ground of each hole by the GPS module 22, and may determine whether or not the user's shot is the tee shot.

The first input unit 233 obtains the number information on the golf club 1 from the club device 10 through the communication unit 21, and inputs the data to the data registration unit 236. Further, the first input unit 233 obtains, from the club device 10, the sound data that is generated when the user swings the golf club 1, and inputs the data to the data registration unit 236.

The second input unit 234 obtains the information on environment in which the user uses the golf club 1 (wind direction, wind speed, temperature, humidity, and the like) from the cart device 40 through the communication unit 21, and inputs the information to the data registration unit 236.

The third input unit 235 obtains the information on the posture of the user when the user uses the golf club 1, from the shoe devices 30R and 30L through the communication unit 21, and inputs the information to the data registration unit 236.

The data registration unit 236 controls the storage unit 24 to store the information of the use of the golf club 1. Specifically, when the user uses the golf club 1, the data registration unit 236 controls the storage unit 24 to store the information on the club used by the user, the information on the environment, and the information on the posture of the user in association with one another, on the basis of the received data.

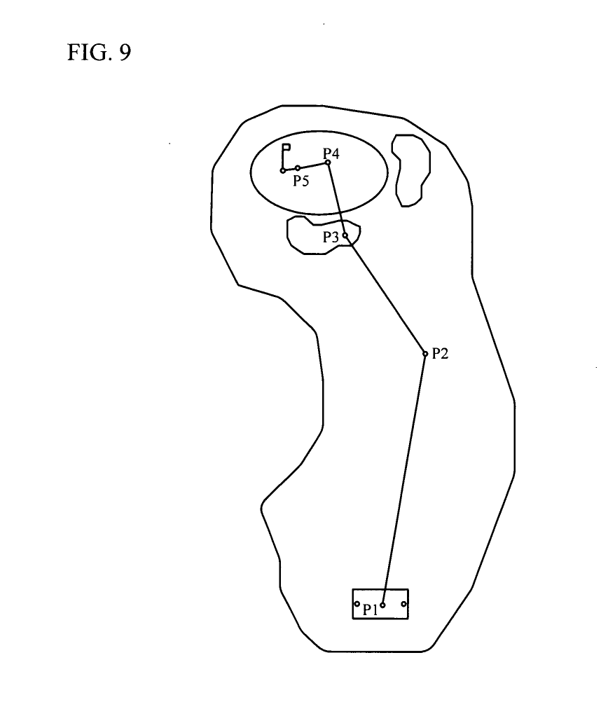

Further, when the determination result which the data registration unit 236 obtains from the determination unit 232 means that the user's shot was not the tee shot, the data registration unit 236 calculates the flight distance of the ball in the (n−1)th shot, on the basis of the received position information of the user in the nth and the (n−1)th shots, and controls the storage unit 24 to store the data. Additionally, the calculation of the flight distance of the ball will be described later with reference to FIG. 9.

When the user is playing on the golf course where the user has already played, the report unit 237 reports the previous play information to the user. For example, when the position information of the user input by the position obtaining unit 231 is included in the play information (previous play information) stored in the storage unit 24, the report unit 237 instructs the display control unit 238 to display this play information on the display unit 26. It is therefore possible for the user to check the data of the previous play information on the same golf course on the display unit 26. In this case, for example, selected clubs and unselected clubs among plural clubs held by the user may be displayed, and the result obtained by using the selected club (for example, flight distance) may be displayed. Further, on the basis of a comparison between the last flight distance and the average flight distance obtained by using the selected club, whether the last shot was a good shot or miss shot may be displayed.

The display control unit 238 controls the display unit 26 to display the play information stored in the storage unit 24 in response to the instruction from the report unit 237. Also, the display control unit 238 controls the display unit 26 to display the play information stored in the storage unit 24 in response to the operation of the mobile terminal 2 by the user.

The transmission unit 239 transmits the play information stored in the storage unit 24 to an external device. Herein, the external device is, for example, a personal computer connectable to the Internet, a mobile device of another user, or the like. It is thus possible to share the play information with others. Further, it is possible to share the information on faults with others and the information on which route enables holing out with good score. Furthermore, it is possible to feed back previous faults of the user.

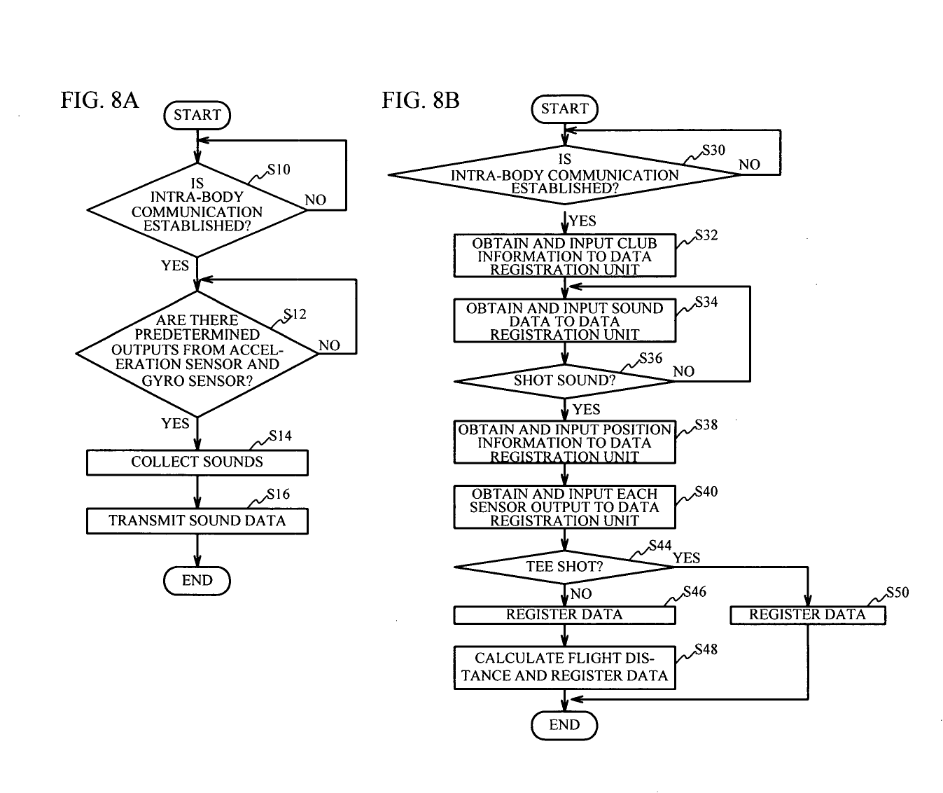

Next, a description will be given of an example of process executed by the control unit 14 of the club device 10 and the control unit 23 of the mobile terminal 2. FIG. 8A is a flowchart of an example of the process executed by the control unit 14 of the club device 10. Further, FIG. 8B is a flowchart of an example of the process executed by the control unit 23 of the mobile terminal 2.

(Process Executed by the Control Unit 14 of the Club Device 10)

First, a description will be given of an example of the process executed by the control unit 14 of the club device 10 with reference to the flowchart in FIG. 8A. Firstly, in the process in the FIG. 8A, in step S10, the control unit 14 determines whether or not intra-body communication with the mobile terminal 2 is established. When a negative determination is made in this step, that is, when intra-body communication with the mobile terminal 2 is not established, the control unit 14 repeats the process of step S10 until a determination is made in step S10. Alternatively, it may be detected that the user grips or holds the golf club 1 by use of the electrode portion of the intra-body communication unit 162, and this flowchart may be started. Then, when a positive determination is made in step S10, that is, when intra-body communication with the mobile terminal 2 is established, the control unit 14 shifts to step S12 and determines whether or not there are predetermined outputs from the acceleration sensor 11 and the gyro sensor 12. In this step S12, the control unit 14 determines whether or not there are predetermined outputs from the acceleration sensor 11 and the gyro sensor 12, thereby determining whether or not the golf club 1 is swung by the user.

When a negative determination is made in step S12, that is, when there is no predetermined output from the acceleration sensor 11 and the gyro sensor 12, the control unit 14 executes the process in step S12, until there are predetermined outputs from the acceleration sensor 11 and the gyro sensor 12. Then, when there are predetermined outputs from the acceleration sensor 11 and the gyro sensor 12, a positive determination is made in step S12, and the process proceeds to the step S14.

When the process proceeds to the step S14, the control unit 14 collect sounds by the microphone 13. In this case, when the user shoots the ball, a shot sound is collected by the microphone 13. Additionally, in the present embodiment, the shot sound is collected by the microphone 13, because of determining whether or not the shot is a practice one.

Subsequently, in step S16, the control unit 14 transmits the sound data of sounds collected in step S14 to the mobile terminal 2 through the communication unit 16, and then all of the process in FIG. 8A is finished. Outputs from at least one of the acceleration sensor 11 and the gyro sensor 12 may be transmitted together with the sound data. The mobile terminal 2 can determine whether the user performs a full or half swing on the basis of the outputs from at least one of the acceleration sensor 11 and the gyro sensor 12.

Additionally, the process of FIG. 8A is repeated afterward.

(Process Executed by the Control Unit 23 of the Mobile Terminal 2)

Next, a description will be given of an example of the process executed by the control unit 23 of the mobile terminal 2 (each unit in FIG. 7) with reference to the flowchart in FIG. 8B.

In the process in FIG. 8B, firstly, in step S30, the first input unit 233 determines whether or not intra-body communication with the golf club 1 is established. When a negative determination is made in this step, that is, when intra-body communication with the golf club 1 is not established, the first input unit 233 repeats the process of step S30 until a positive determination is made. On the other hand, when intra-body communication with the golf club 1 is established, a positive determination is made in step S30, and the process proceeds to step S32.

When the process proceeds to step S32, the first input unit 233 obtains the number information on the club from the golf club 1, and inputs the information to the data registration unit. Then, in step S34, the first input unit 233 obtains the sound data of sounds collected by the microphone 13 (step S14 in FIG. 8A) from the golf club 1, and inputs the data to the data registration unit 236. In addition, when the user has plural golf clubs 1, the number information on the unselected (unused) club may be input to the data registration unit 236.

Subsequently, in step S36, for example, the data registration unit 236 performs a frequency analysis on the sound data, and determines whether or not the obtained sound is the shot sound. Additionally, this determination in step S36 means the determination whether or not the user uses the golf club corresponding to the number information obtained in step S32. When a negative determination is made in step S36, that is, when the obtained sound is not the shot sound, the process proceeds to step S38. In addition, instead of the shot sound, user's voice such as “Ahh” (a voice when a miss shot is made), or another user's voice such as “nice shot” may be used.

When the process proceeds to step S38, the position obtaining unit 231 obtains the position information of the user by use of the GPS module 22, and inputs the information to the data registration unit 236.

Next, in step S40, the second and third input units 234 and 235 obtain outputs from each sensor, and inputs them to the data registration unit 236. Specifically, the second input unit 234 obtains the information on wind direction, temperature, humidity, and time, from the cart device 40, and inputs the information to the data registration unit 236. Also, the third input unit 235 obtains the information on the posture of the user from the shoe devices 30R and 30L, and inputs the information to the data registration unit 236.

Next, in step S44, the determination unit 232 determines whether or not the user's shot by use of the golf club is the tee shot. For example, the determination unit 232 can determines that the user's shot is the tee shot by use of the number information on the club, when a comparatively long club (driver or one of 3 to 9 irons) is used after the putter is used, or when the user's shot is the first one in the day. Further, as described above, the position of each tee ground may be detected by the GPS module 22.

When a positive determination is made in step S44, that is, when the user's shot is the tee shot, the process proceeds to step S50, and the data registration unit 236 registers the obtained data with the storage unit 24. In this case, the data registration unit 236 controls the storage unit 24 to store the number information on the club, the position information of the user, the information on wind direction, temperature, humidity, and time, and the posture information of the user in accordance with one another.

In contrast, when a positive determination is made in step S44, that is, when it is not the tee shot, the process proceeds to step S46, and the data registration unit 236 registers the obtained data with the storage unit 24. In this case, the data registration unit 236 controls the storage unit 24 to store the number information on the club, the position information of the user, the information on wind direction, temperature, humidity, and time, and the posture information of the user in accordance with one another.

Next, in step S48, the data registration unit 236 calculates the flight distance of the ball, and controls the storage unit 24 to store the calculated flight distance as the data on the (n−1)th shot. In this case, the data registration unit 236 calculates the distance between the position where the nth shot is performed and the position where the (n−1)th shot is performed, thereby calculating the flight distance. In this way, the entire process in FIG. 8B is finished.

Additionally, the process in FIG. 8B is repeated thereafter.

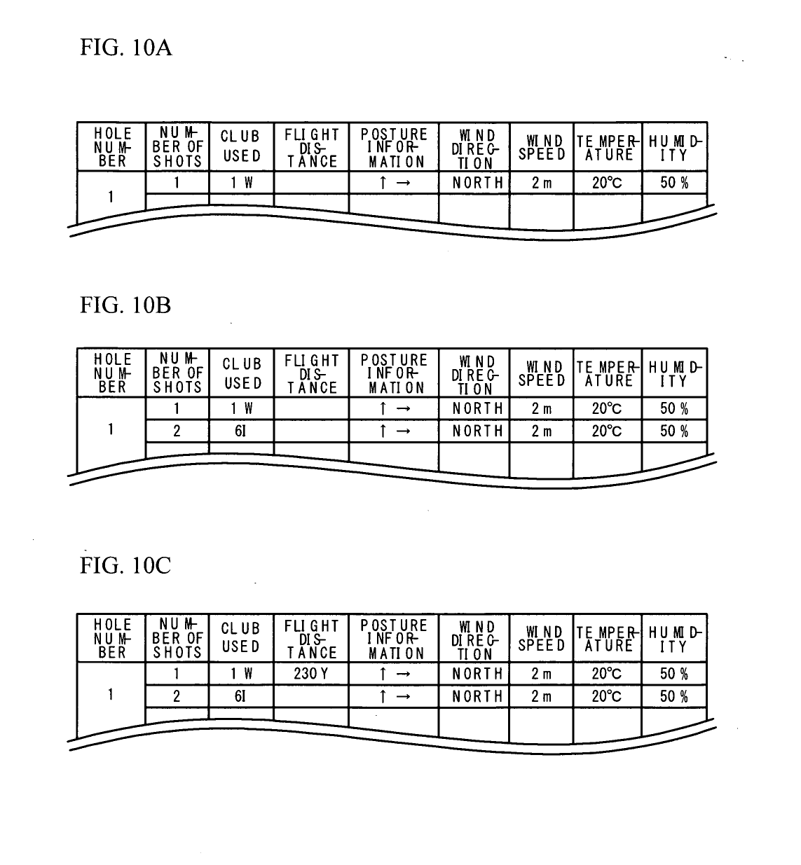

Herein, the process in FIG. 8B will be described in detail with reference to FIGS. 9, 10A to 10C.

FIG. 9 is a view illustrating an example of a golf course. In a position P1 in FIG. 9, presume that the user performs the tee shot. In this case, as illustrated in FIG. 10A, the data of the first shot (except for the data of the flight distance) are registered (S50).

Next, after moving to a position P2 in FIG. 9, presume that the user performs the second shot. In this case, as illustrated in FIG. 10B, the data of the second shot (except for the data of the flight distance) are registered (S46). Further, since the flight distance of the first shot can be calculated based on the position of the second shot and the position of the first shot (tee shot), as illustrated in FIG. 100, the data of the flight distance of the first shot is registered (S48). That is, in the present embodiment, on the basis of two positions where respective shot sounds are generated, the control unit 23 calculates the flight distance.

After that, in each of positions P3, P4, and P5, every time the ball is shot, the data are stored. Additionally, the flight-distance data are stored for each used golf club 1, each way to grip the golf club 1 (the end side or the bottom side), and each degree of force applied by the user by the acceleration sensor 11 and the gyro sensor 12, whereby the average flight distance of the user for each situation is obtained. On the basis of this average flight distance for each situation and the flight distance of the play, the control unit 23 may determine whether or not the shot is a miss shot. At this time, a parameter such as the posture information and the environment condition (wind speed, temperature, and the like) may be added. Further, at this time, on the basis of the course layout, in consideration of the position information, for example, indicating a case where the flight distance is adequate but the ball is shot from the next hole, it may be determined whether or not the shot is a miss shot. Furthermore, the pre-shot routine of the user before shooting the ball (the number of practice shots, time, the way to move the body, and the like) may be detected by each sensor and may be stored in the storage unit 24.

As described above in detail, in the present embodiment, the mobile terminal 2 includes: the communication unit 21 that communicates with the golf club 1 through intra-body communication via the user or near field communication (for example, Bluetooth(registered trademark) or RFID (Radio Frequency Identification)); the position obtaining unit 231 that obtains the position information of the user; and

the storage unit 24 that stores the information on the use of the golf club 1 on the basis of the communication history between the golf club 1 and the communication unit 21, and the position information of the user. Thus, when the user uses the golf club 1, the play information (information on the use of the golf club 1) is recorded in the mobile terminal 2. Thus, the user can easily record the play information without being forced to do particular operation. Further, even in a case of not being recorded by the user, the user can check the information on when or where the golf club 1 is used, after the play.

Further, in the present embodiment, since the storage unit 24 stores the information on the user of the golf club 1 in association with the movement distance of the user based on the position information on the user, the user can easily record the flight distance of the ball in using the golf club 1, without being forced to do particular operation. Furthermore, the user can check the flight distance of the ball in using the golf club 1, after playing.

Additionally, in the present embodiment, since the communication unit 21 is capable of communicating with a golf club different from the golf club 1 (for example, different number golf club) through intra-body communication or near field communication, and the communication unit 21 includes the determination unit 232 determining the movement distance of the user depending on communication between the golf club 1 and the communication unit 21, the flight distance of the ball by each number of the club can be recorded.

Further, in the present embodiment, the mobile terminal 2 includes the first input unit 233 inputting the sound data generated by using the golf club 1, and the storage unit 24 stores the information on the use of the golf club 1 when the sound of the sound data is the shot sound. This can prevent the storage unit 24 from storing the data of the practice shot and the like, thereby recording the accurate score.

Furthermore, in the present embodiment, the mobile terminal 2 includes the second input unit 234 inputting the information on environment such as wind direction, wind speed, temperature, and humidity in the position where the golf club 1 is used, and the storage unit 24 stores the information of the use of the golf club 1 in association with the information on environment of the position where the golf club 1 is used. Since the information on environment of the position where the golf club 1 is used is stored in the storage unit 24, the user can check wind direction, wind speed, temperature, and humidity in the position which the golf club 1 is used, after the play.

Further, in the present embodiment, the mobile terminal 2 includes the third input unit 235 that inputs the information on the posture of the user, and the storage unit 24 stores the information on the posture of the user in association with each shot. Therefore, the user can check the posture in the nth shot, after the play.

Further, in the present embodiment, since the mobile terminal 2 includes the display unit 26 that displays the information stored in the storage unit 24, the user can easily check the play information stored in the storage unit 24.

Furthermore, in the present embodiment, since the mobile terminal 2 includes the transmission unit 239 that transmits the information stored in the storage unit 24 to an external device, it is possible to share the play information with others. Further, it is possible to share the information on faults of others and the information on which route enables holing out with good score. Furthermore, it is possible to feed back the previous faults of the user.

Further, in the present embodiment, the mobile terminal 2 includes the report unit 237 that reports the information stored in the storage unit 24 to the user depending on the position information obtained by the position obtaining unit 231. Thus, when the user comes to the course where the user have ever played, the user can check the previous play information as a reference of the next play.

Additionally, in the above embodiment, a description has been given of the determination unit 232 that determines whether or not the last swing was the tee shot on the basis of the number information on the golf club, but it is not limited thereto. For example, on the basis of the number information on the golf club and the position information of the user, the determination unit 232 may determines whether or not the user's shot is the tee shot. Therefore, even when the club with the same number is successively used, the flight distance can be calculated under the conditions under which the positions of the user are different to some extent (for example, distance set beforehand (10 yards)). It is thus possible to adequate record the play information of a beginner who often uses the same number club. Also, the position of the tee shot is set beforehand in each hole, the determination unit 232 may determine whether or not the last swing is the tee shot on the basis of the position information of the user.

Additionally, in the above embodiment, in a case where the user has plural golf clubs each having different number (for example, two clubs), when the user uses any one of them and does not use another, the storage unit 24 may store the information on the unused club in association with the information on the used club. Thus, after playing, the user can check the information on the unused club in the nth shot as a reference for the next play.

In the above embodiments, the club device 10 provided in the golf club 1 includes the acceleration sensor 11 and the gyro sensor 12. However, the acceleration sensor 11 and the gyro sensor 12 may be provided in the mobile terminal 2, and the swing of the user may be detected by the mobile terminal 2. Further, in the above embodiment, although the club device 10 includes the microphone 13, the mobile terminal 2 may include the microphone 13 and collect the sound data in using the golf club 1. In this case, the control unit 23 of the mobile terminal 2 may execute the process that is executed by the control unit 14 of the club device 10 described in FIG. 8A. Also, the microphone may be provided in the shoe 3. In this case, the microphone may be provided in both or one of shoe devices 30R and 30L. For a right hander, the microphone may be provided in the shoe device 30L, because the ball is in the vicinity of a left foot of the right hander. For a left hander, the microphone may be provided in the shoe device 30R, because the ball is in the vicinity of a right foot of the left hander.

Additionally, in the above embodiment, a description has been given of the first input unit 233 of the mobile terminal 2 that obtains the sound data collected by the microphone 13 of the club device 10 in using the golf club 1, but not limited thereto. The first input unit 233 may input the information other than the sound data generated by using the golf club 1. Even in such a case, the data registration unit 236 can register the play information with the storage unit 24 on the basis of the information input by the first input unit 233.

For example, in a case where the club device 10 is provided with a pressure sensor, at the head portion of the golf club 1, instead of or together with the microphone 13, the first input unit 233 may input the output value from the pressure sensor to the first input unit 233. In this case, for example, when the output value from the pressure sensor is greater than a threshold value, the data registration unit 236 can determine that the user shoots the ball and can register the play information with the storage unit 24. In addition, it is considerable that the acceleration and the angular velocity of the golf club 1 is changed at the moment when the ball is shot (for example, the acceleration and the angular velocity are reduced depending on the weight of the ball at the moment when the ball is shot). For this reason, on the basis of outputs from one or both of the acceleration sensor 11 and the gyro sensor 12 provided in the club device 10, the data registration unit 236 may determine whether or not the user shoots the ball.

Alternatively, in order to measure the impact transmitted to the user in shooting the ball, the pressure sensor may be attached to a wrist or an arm of the user, the grip of the golf club 1, or the like, and the first input unit 233 may input outputs from the pressure sensor. In this case, for example, when the output value from the pressure sensor is greater than a threshold value, the data registration unit 236 may determine that the user shoots the ball and may register the play information with the storage unit 24.

Also, for example, in a case where the club device 10 includes a mechanical switch instead of or together with the microphone 13, the first input unit 233 may input the information on ON and OFF of the mechanical switch. Specifically, the mechanical switch is provide at the end portion of the grip in the golf club 1, and the user pushes the mechanical switch before or after shooting the ball. In such a way, when the mechanical switch is pushed, the data registration unit 236 can determine that the user shoots the ball and can register the play information with the storage unit 24.

Further, when the user shoots the ball, the first input unit 233 may input the information on the operation on the mobile terminal 2 by the user. For example, before or after shooting the ball, the user performs the predetermined operation on the mobile terminal 2 (for example, pushing a “register button”). In this case, when the predetermined operation on the mobile terminal 2 is performed, the data registration unit 236 can determine the user shoots the ball and can register the play information with the storage unit 24.

Further, in the above embodiment, a description has been given of providing the GPS module 22 in the mobile terminal 2, but is not limited thereto. For example, a GPS module may be provided in the golf club 1, shoes 3R and 3L, the cart 4, or the like.

Furthermore, in the above embodiment, although the storage unit 15 of the club device 10 provided in the golf club 1 stores the number information as the information on the golf club 1, the storage unit 15 may store not only the number information but also a golf club manufacturer and a type of shaft (iron shaft or carbon shaft). It is thus possible to record more detailed play information, and the user can check afterwards the influence on the play caused by the difference of the club.

Additionally, in the above embodiment, although the shoes 3R and 3L are provided with the load sensors to detect the posture of the user, for example, a spirit level may be used to detect the posture of the user, instead of the load sensor.

Also, in the above embodiment, a description has been given of the card device 40 having a function to obtain the information on environment such as wind direction, temperature, humidity, and the like, but is not limited thereto. All or a part of functions of the cart device 40 may be given to, for example, a golf bag, a wear or a hat which the user wears.

Further, in the above embodiment, a description has been given of the mobile terminal with a hand size and a phone function (smartphone) as an example, but the above embodiment is applicable to another mobile terminal such as a tablet computer.

In the above embodiment, a description has been given to as an example of golf, but the present invention is applicable to sports other than golf. For example, in a case of being applied to baseball, it is possible to automatically obtain the data whether the user grips the end or the bottom of a grip of a bat or whether the user performs full or half swing. In a case of being applied to Kendo, it is possible to automatically obtain the data on the swing of a bamboo sword.

While the exemplary embodiments of the present invention have been illustrated in detail, the present invention is not limited to the above-mentioned embodiments, and other embodiments, variations and modifications may be made without departing from the scope of the present invention. The entire disclosure of the publication cited in the above description is incorporated herein by reference.

1. An electronic device comprising:
a communication unit that communicates with a first device having a first sensor, the first device cooperating with a first kit;
a position detector that detects position information of a user; and
a storage unit that stores an output of the first sensor and the position information of the user.

2. (canceled)

3. The electronic device according to claim 1, wherein
the communication unit is capable of communicating with a second device having a second sensor, the second device cooperating with a second kit different from the first kit; and
comprising
a determination unit that determines a movement distance of the user depending on communication between the communication unit and at least one of the first device and the second device.

4. The electronic device according to claim 1, comprising an input unit that inputs the output of the first sensor acquired by the first kit, wherein
the storage unit stores the information acquired by the first kit.

5. The electronic device according to claim 4, wherein the acquired by the first kit is sound information.

6. The electronic device according to claim 1, further comprising an input unit that inputs environmental information of a position where the first kit is used, wherein
the storage unit stores the environmental information.

7. The electronic device according to claim 1, further comprising an input unit that inputs posture information of the user, wherein
the storage unit stores the posture information.

8. The electronic device according to claim 1, wherein
the communication unit is capable of communicating with a second device having a second sensor, the second device cooperating with a second kit different from the first kit; and
when the user has the first kit and the second kit and uses one of the first kit or the second kit without using the other one, the storage unit stores information on an unused kit in association with information on a used kit.

9. (canceled)

10. The electronic device according to claim 1, further comprising a transmission unit that transmits the information stored in the storage unit to an external device.

11. The electronic device according to claim 1, further comprising a report unit that reports the information stored in the storage unit to the user based on the user's position detected by the position detector.

12. An electronic device comprising:
a communication unit that communicates with a first device having a sensor, the first device cooperating with a first kit; and
a storage unit that stores information on a way to hold and swing the first kit based on the sensor.

13. The electronic device according to claim 1, wherein the position detector detects the position information of the user based on the output of the first sensor.

14. The electronic device according to claim 1, wherein the storage unit stores a first positional information by the position detector based on a first output of the first sensor, and a second positional information by the position detector based on a second output of the first sensor.

15. The electronic device according to claim 14, wherein the storage unit stores a distance between the first positional information and the second positional information.

16. The electronic device according to claim 15, wherein the storage unit stores the distance relating to the first output of the first sensor.

17. The electronic device according to claim 1, further comprising a display that displays distance information, the distance information being based on a first positional information by the position detector based on a first output of the first sensor and a second positional information by the position detector based on a second output of the first sensor.

18. The electronic device according to claim 12, further comprising a position detector that detects position information of a user.

19. The electronic device according to claim 18, wherein the position detector detects the position information of the user based on the output of the sensor.

20. The electronic device according to claim 18, wherein the storage unit stores a first positional information by the position detector based on a first output of the sensor, and a second positional information by the position detector based on a second output of the sensor.

21. The electronic device according to claim 20, wherein the storage unit stores a distance between the first positional information and the second positional information.

22. The electronic device according to claim 21, wherein the storage unit stores the distance relating to the first output of the sensor.

23. The electronic device according to claim 18, further comprising a display that displays distance information, the distance information being based on a first positional information by the position detector based on a first output of the sensor and a second positional information by the position detector based on a second output of the sensor.

24. A computer-readable computer program product containing a program for an electronic device that is executed by a computer, the program comprising:
communicating with a device having a sensor, the device cooperating with a kit;
detecting position information of a user by a position detector; and
storing an output of the sensor and the position information of the user.

25. The computer-readable computer program according to claim 24, comprising detecting the position information of the user based on the output of the sensor.

26. The computer-readable computer program according to claim 24, comprising storing a first positional information by the position detector based on a first output of the sensor and a second positional information by the position detector based on a second output of the sensor.

27. The computer-readable computer program according to claim 26, comprising storing a distance between the first positional information and the second positional information.

28. The computer-readable computer program according to claim 27, comprising storing the distance relating to the first output of the sensor.

29. The computer-readable computer program according to claim 24, further comprising displaying distance information, the distance information being based on a first positional information by the position detector based on a first output of the sensor and a second positional information by the position detector based on a second output of the sensor.
